(19) United States
(12) Patent Application Publication
(10) Pub. No.: US 2025/0286232 A1
(43) Pub. Date: Sep. 11, 2025

(54) TRACTION BATTERY BUSBAR ASSEMBLY LOCKING BAR

(71) Applicant: Ford Global Technologies, LLC, Dearborn, MI (US)

(72) Inventors: Chris James Leck, Enfield (GB); Hamish Macwillson, Colchester (GB); Ronnie Thomas, South Woodham Ferrers (GB)

(21) Appl. No.: 18/595,843

(22) Filed: Mar. 5, 2024

(51) Int. Cl. H01M 50/503; B60L 50/64; H01M 10/0525; H01M 50/211; H01M 50/262; H01M 50/271; H01M 50/507; H01M 50/516

(52) U.S. Cl. CPC H01M 50/503; H01M 10/0525; H01M 50/211; H01M 50/262; H01M 50/271; H01M 50/507; H01M 50/516; B60L 50/64; H01M 2220/20

(57) ABSTRACT

A traction battery pack assembly includes a busbar assembly having at a frame and at least one busbar. The frame includes a plurality of fingers. A locking bar has a plurality of apertures that are each configured to receive a portion of one or more of the fingers to constrain the busbar assembly.

### TECHNICAL FIELD

This disclosure relates generally to using a locking bar to constrain movement of a busbar assembly of a traction battery pack, particularly vibrations of the busbar assembly.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack assembly, including: a busbar assembly having at a frame and at least one busbar, the frame including a plurality of fingers; and a locking bar have a plurality of apertures that are each configured to receive a portion of one or more of the fingers to constrain the busbar assembly.

In some aspects, the techniques described herein relate to a traction battery pack assembly, wherein the busbar assembly is pivotably coupled to a cover that spans a cell stack.

In some aspects, the techniques described herein relate to a traction battery pack assembly, wherein the locking bar is a first locking bar and the plurality of apertures are a first plurality of apertures, the busbar assembly is a first busbar assembly pivotably coupled to a first side of the cover, the frame is a first frame, the plurality of fingers is a plurality of first fingers, and further including a second busbar assembly and a second locking bar, the second busbar assembly having a second frame with a second plurality of fingers and at least one second busbar, the second locking bar having a second plurality of apertures, the second plurality of apertures configured to receive a portion of one or more of the second plurality of fingers to constrain the second busbar assembly.

In some aspects, the techniques described herein relate to a traction battery pack assembly, further including a cell stack, the first busbar assembly and first locking bar disposed along a first side of the cell stack, the second busbar assembly and the second locking bar disposed along an opposite, second side of the cell stack.

In some aspects, the techniques described herein relate to a traction battery pack assembly, wherein the first busbar assembly is pivotably coupled to a first side of a cover that spans the cell stack, and the second busbar assembly is pivotably coupled to an opposite, second side of the cover.

In some aspects, the techniques described herein relate to a traction battery pack assembly, wherein each of the apertures within the plurality of apertures receive one of the fingers within the plurality of fingers.

In some aspects, the techniques described herein relate to a traction battery pack assembly, wherein the plurality of fingers are tapered.

In some aspects, the techniques described herein relate to a traction battery pack assembly, wherein the plurality of apertures are a plurality of pockets, the locking bar disposed circumferentially completely about the portion of one or more of the fingers within the plurality of fingers to constrain the busbar assembly.

In some aspects, the techniques described herein relate to a traction battery pack assembly, further including a cell stack having a plurality of battery cells disposed along an axis, the plurality of battery cells positioned between compressive structures that are at opposing axial ends of the cell stack, the busbar assembly and locking bar disposed along a side of the cell stack, the locking bar clipped to the compressive structures.

In some aspects, the techniques described herein relate to a traction battery pack assembly, wherein the compressive structures are cross-members.

In some aspects, the techniques described herein relate to a traction battery pack assembly, further including a cell stack having a plurality of battery cells with tab terminals, wherein the frame includes a plurality of slots the tab terminals received within the plurality of slots.

In some aspects, the techniques described herein relate to a method of assembling a battery pack, including: securing a locking bar relative to a cell stack; moving a busbar assembly into an installed position relative to the cell stack, the busbar assembly including a plurality of busbars mounted to a frame; and during the moving, inserting a plurality of fingers of the frame into a plurality of apertures of the locking bar.

In some aspects, the techniques described herein relate to a method, further including inhibiting vibration of the plurality of fingers using the locking bar.

In some aspects, the techniques described herein relate to a method, further including constraining movement of the plurality of fingers using the locking bar.

In some aspects, the techniques described herein relate to a method, further including clipping the locking bar to at least one compressive structure when securing the locking bar.

In some aspects, the techniques described herein relate to a method, further including securing a plurality of tab terminals of the cell stack to the plurality of busbars.

In some aspects, the techniques described herein relate to a method, wherein the securing including welding the plurality of tab terminals to at least one of the busbars within the plurality of busbars.

In some aspects, the techniques described herein relate to a method, wherein the busbar assembly is pivotably secured to a cover that spans a cell stack when the plurality of fingers are received within the plurality of apertures of the locking bar.

In some aspects, the techniques described herein relate to a method, wherein the busbar assembly is a first busbar assembly disposed along a first side of the cell stack, and further including disposing a second busbar assembly along an opposite, second side of the cell stack, the second busbar pivotably secured to the cover.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates a battery cell from the battery pack of FIG. 2.

FIG. 4 illustrates a locking bar from the battery pack of FIG. 2.

FIG. 5 illustrates a portion of a busbar module in an installed position where fingers of the busbar module are constrained by the locking bar of FIG. 4.

FIG. 6 illustrates a section view taken at line 6-6 in FIG. 5.

### DETAILED DESCRIPTION

This disclosure details example locking bars that can be used to constrain busbar modules within a battery pack and inhibit vibration. The locking bars can help support the busbar modules when tab terminals are secured to busbars of the busbar modules.

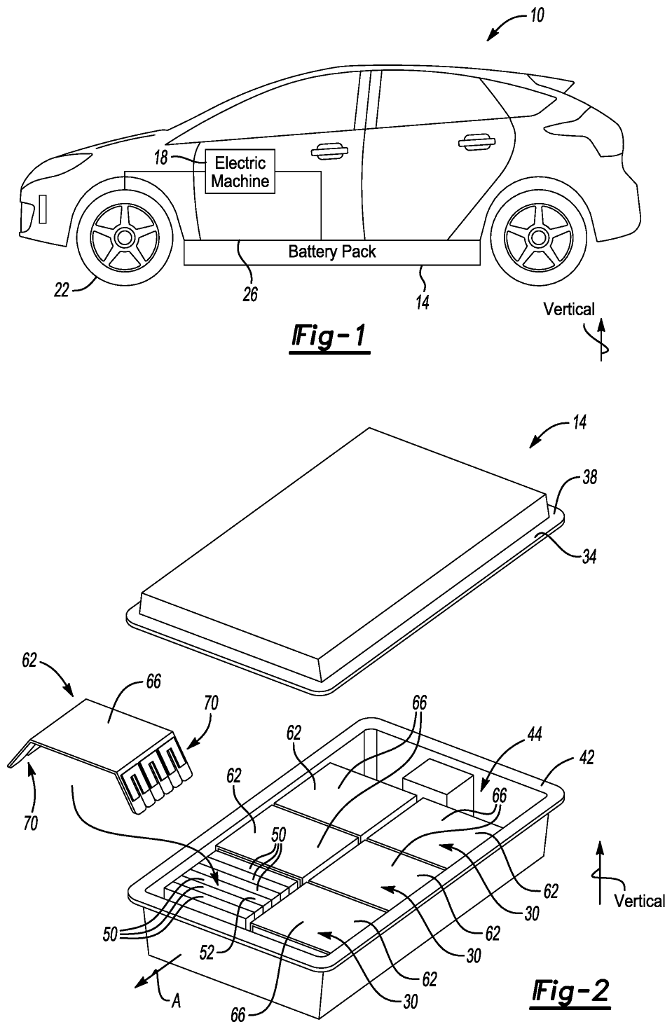

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

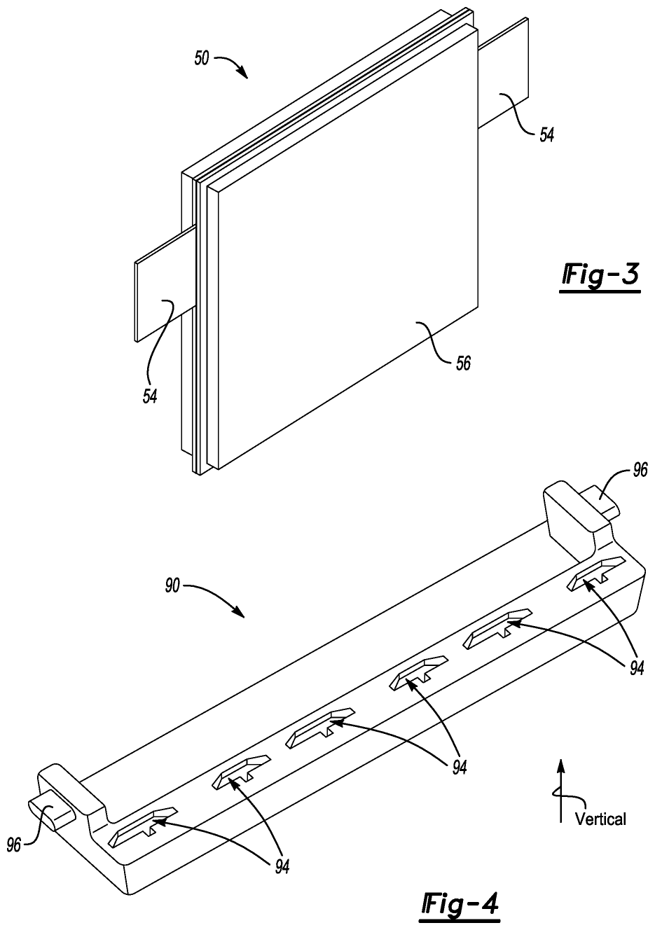

With reference now to FIGS. 2 and 3, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes, among other things, a plurality of battery cells 50 (or simply “cells”) stacked side-by-side relative to each along a respective cell stack axis A. In this example, the axes A of the cell stacks 30 extend longitudinally from a forward end to a rearward end of the vehicle 10.

The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure.

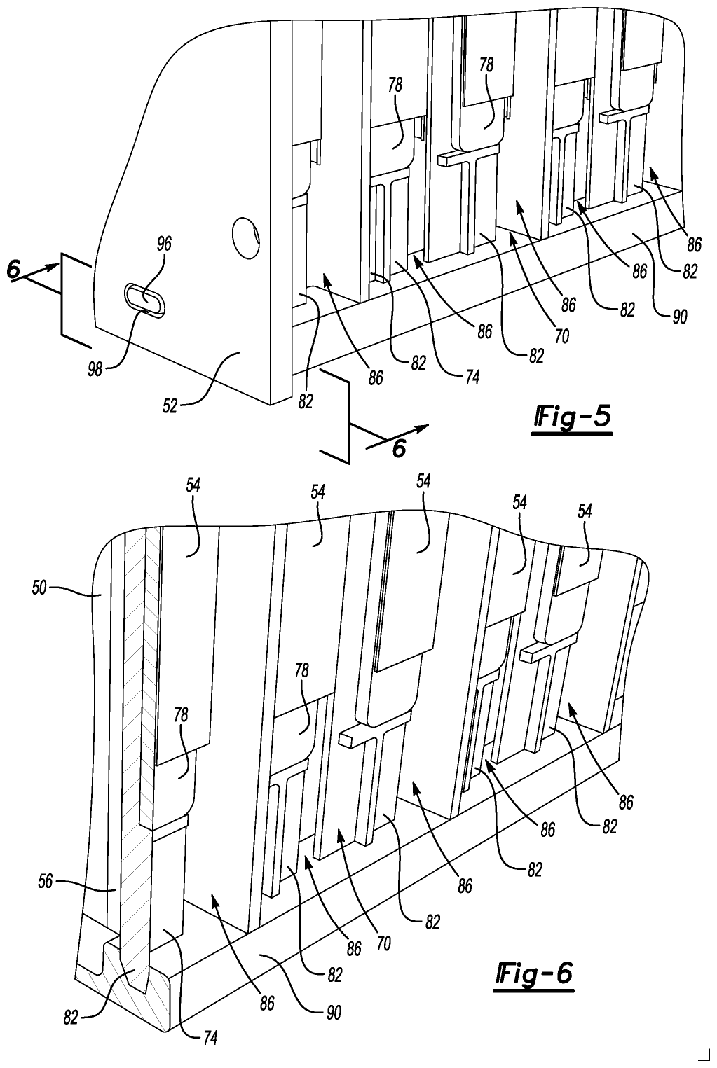

With reference now to FIGS. 4-6 and continuing reference to FIGS. 1-3, the cell stacks 30 are each sandwiched along their axis A between compressive structures 52, which are disposed at opposing axial ends of the cell stacks 30. In this example, the compressive structures 52 are cross-members within the enclosure tray 42. In another example, the compressive structures 52 are part of the enclosure assembly 34, such as the enclosure cover 38 or the enclosure tray 42. In still other examples, the compressive structures 52 are endplates. The compressive structures 52 are compressive as the compressive structures 52 maintain the cell stack 30 in a compressed state along the respective axis A.

Each of the example battery cells 50 includes a pair of tab terminals 54 extending from a case 56. Within a given one of the cell stacks 30, the individual battery cells 50 can be electrically connected together. To provide these electrical connections, the tab terminals 54 of the battery cells 50 can be connected to the tab terminals 54 of other battery cells 50.

In this example, an interconnector assembly 62 is associated with each of the cell stacks 30. The interconnector assemblies 62 each include a cover 66 and a pair of busbar assemblies 70. One of the busbar assemblies 70 is pivotably coupled to each side of the cover 66. When the interconnector assembly 62 is installed, the cover 66 of the interconnector assembly 62 spans the respective cell stack 30, with the busbar assemblies 70 disposed along opposite sides of the respective cell stack 30.

The busbar assemblies 70 each include a frame 74 and a plurality of busbars 78 mounted to the frame 74. In this example, the busbars 78 are mounted to the frame 74 using heat stakes.

The frame 74 includes a plurality of fingers 82. Slots 86 are positioned between the fingers 82. When the interconnector assembly 62 is moved to an installed position, the tab terminals 54 are received within one of the slots 86. The tab terminals 54 are then folded over and secured to one of the busbars 78. In this example, the tab terminals 54 are welded to the busbars 78 after being folded over.

The battery pack 14 includes locking bars 90 that are disposed along each side of the cell stacks 30. The locking bars 90 include a plurality of apertures 94. In this example, the apertures 94 are pockets that open vertically upward, and that do not open to a side of the locking bars 90. In another example, the apertures 94 could be slots that open to one or more sides of the locking bars 90. Vertical and horizontal, for purposes of this disclosure, is with reference to ground and a general orientation of the vehicle 10 and battery pack 14 during operation.

As the busbar assemblies 70 are moved to an installed position where the tab terminals 54 are received within the slots 86 of the frame 74, a portion of each of the fingers 82 is inserted into one of the apertures 94. When the portion of the fingers 82 is received with each of the apertures 94, movement of the fingers 82 is constrained. The fingers 82 are tapered to facilitate insertion into the apertures 94.

In this example, the locking bars 90 constrain at least horizontal movements and vibrations of the fingers 82. Each of the apertures 94 receives a portion of one of the fingers 82—here a tip of the fingers 82. In another example, the apertures 94 could receive portions of more than one of the fingers 82.

When the fingers 82 are received within the apertures 94, the locking bars 90 are disposed circumferentially completely about the portion of one or more of the fingers 82 to constrain the busbar assembly 70.

Constraining movement of the fingers 82 can help to inhibit vibration of the fingers 82 when, for example, the vehicle 10 is driven. Constraining movement of the fingers 82 can also help brace the fingers 82 when the tab terminals 54 are welded to the busbars 78.

The locking bars 90, in this example, clip into the compressive structures 52 to secure the locking bars 90. In this example, protrusions 96 at opposite ends of the locking bars 90 are received within apertures 98 of the compressive structures 52 to clip the locking bars 90 into the compressive structures 52. The locking bars 90 could instead or additionally be mechanically fastened to the enclosure tray 42 using threaded fasteners, such as bolts.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a busbar assembly having at a frame and at least one busbar, the frame including a plurality of fingers; and
a locking bar have a plurality of apertures that are each configured to receive a portion of one or more of the fingers to constrain the busbar assembly.

2. The traction battery pack assembly of claim 1, wherein the busbar assembly is pivotably coupled to a cover that spans a cell stack.

3. The traction battery pack assembly of claim 2, wherein the locking bar is a first locking bar and the plurality of apertures are a first plurality of apertures, the busbar assembly is a first busbar assembly pivotably coupled to a first side of the cover, the frame is a first frame, the plurality of fingers is a plurality of first fingers, and further comprising a second busbar assembly and a second locking bar,
the second busbar assembly having a second frame with a second plurality of fingers and at least one second busbar, the second locking bar having a second plurality of apertures, the second plurality of apertures configured to receive a portion of one or more of the second plurality of fingers to constrain the second busbar assembly.

4. The traction battery pack assembly of claim 3, further comprising a cell stack, the first busbar assembly and first locking bar disposed along a first side of the cell stack, the second busbar assembly and the second locking bar disposed along an opposite, second side of the cell stack.

5. The traction battery pack assembly of claim 3, wherein the first busbar assembly is pivotably coupled to a first side of a cover that spans the cell stack, and the second busbar assembly is pivotably coupled to an opposite, second side of the cover.

6. The traction battery pack assembly of claim 1, wherein each of the apertures within the plurality of apertures receive one of the fingers within the plurality of fingers.

7. The traction battery pack assembly of claim 1, wherein the plurality of fingers are tapered.

8. The traction battery pack assembly of claim 1, wherein the plurality of apertures are a plurality of pockets, the locking bar disposed circumferentially completely about the portion of one or more of the fingers within the plurality of fingers to constrain the busbar assembly.

9. The traction battery pack assembly of claim 1, further comprising a cell stack having a plurality of battery cells disposed along an axis, the plurality of battery cells positioned between compressive structures that are at opposing axial ends of the cell stack, the busbar assembly and locking bar disposed along a side of the cell stack, the locking bar clipped to the compressive structures.

10. The traction battery pack assembly of claim 9, wherein the compressive structures are cross-members.

11. The traction battery pack assembly of claim 1, further comprising a cell stack having a plurality of battery cells with tab terminals, wherein the frame includes a plurality of slots the tab terminals received within the plurality of slots.

12. A method of assembling a battery pack, comprising:
securing a locking bar relative to a cell stack;
moving a busbar assembly into an installed position relative to the cell stack, the busbar assembly including a plurality of busbars mounted to a frame; and
during the moving, inserting a plurality of fingers of the frame into a plurality of apertures of the locking bar.

13. The method of claim 12, further comprising inhibiting vibration of the plurality of fingers using the locking bar.

14. The method of claim 12, further comprising constraining movement of the plurality of fingers using the locking bar.

15. The method of claim 12, further comprising clipping the locking bar to at least one compressive structure when securing the locking bar.

16. The method of claim 12, further comprising securing a plurality of tab terminals of the cell stack to the plurality of busbars.

17. The method of claim 16, wherein the securing comprising welding the plurality of tab terminals to at least one of the busbars within the plurality of busbars.

18. The method of claim 12, wherein the busbar assembly is pivotably secured to a cover that spans a cell stack when the plurality of fingers are received within the plurality of apertures of the locking bar.

19. The method of claim 18, wherein the busbar assembly is a first busbar assembly disposed along a first side of the cell stack, and further comprising disposing a second busbar assembly along an opposite, second side of the cell stack, the second busbar pivotably secured to the cover.
